(19) United States
(12) Patent Application Publication
(10) Pub. No.: US 2014/0344755 A1
(43) Pub. Date: Nov. 20, 2014

(54) METHOD AND SYSTEM FOR ROTATIONAL LIST BASED USER INTERFACE

(71) Applicant: AVAYA, INC., Basking Ridge, NJ (US)

(72) Inventors: Sameer Shinde, Shivajinagar (IN); Nishant Krishna, Gaya (IN)

(73) Assignee: AVAYA, INC., Basking Ridge, NJ (US)

(21) Appl. No.: 13/895,986

(22) Filed: May 16, 2013

(51) Int. Cl. G06F 3/0482

(52) U.S. Cl. CPC G06F 3/0482
USPC 715/834

(57) ABSTRACT

Disclosed is a system and method for selection of objects appearing in a rotational user interface list. A rotational list in a user interface is enabled to provide text, images, icons, links and scrolling abilities to either end to make components visible or invisible. The rotational list can be made to incorporate variable size icons or images and spacing can be adjusted. A rotational list may respond to priority settings and preferences to provide priority positioning in a geometric shape. Higher priority items may ascent to a narrower portion of the geometric shape and lower priority items may descend to a broader portion of the geometric shape.

### FIELD OF THE INVENTION

The field of the invention relates generally to management of multiple items in a Graphical User Interface.

### BACKGROUND OF THE INVENTION

A graphical user interface (GUI) is a type of user interface that allows users to interact with electronic devices using images rather than text commands. GUIs can be used in computers, hand-held devices such as MP3 players, portable media players or gaming devices, household appliances, office, and industry equipment. A GUI represents the information and actions available to a user through graphical icons and visual indicators such as secondary notation, as opposed to text-based interfaces, typed command labels or text navigation. The actions are usually performed through direct manipulation of the graphical elements.

A GUI uses a combination of technologies and devices to provide a platform that the user can interact with, for the tasks of gathering and producing information. A series of elements conforming a visual language have evolved to represent information stored in computers. This makes it easier for people with few computer skills to work with and use computer software. The most common combination of such elements in GUIs is the WIMP (“window, icon, menu, pointing device”) paradigm, especially in personal computers.

The WIMP style of interaction uses a virtual input device to control the position of a pointer, most often a mouse, and presents information organized in windows and represented with icons. Available commands are compiled together in menus, and actions are performed making gestures with the pointing device. A window manager facilitates the interactions between windows, applications, and the windowing system. The windowing system handles hardware devices such as pointing devices and graphics hardware, as well as the positioning of the pointer.

In personal computers all these elements are modeled through a desktop metaphor, to produce a simulation called a desktop environment in which the display represents a desktop, upon which documents and folders of documents can be placed. Window managers and other software combine to simulate the desktop environment with varying degrees of realism.

The term GUI is restricted to the scope of two-dimensional display screens with display resolutions able to describe generic information, in the tradition of the computer science research at the PARC (Palo Alto Research Center). The term GUI is rarely applied to other low-resolution types of interfaces that are non-generic, such as video games (where HUD is preferred), or not restricted to flat screens, like volumetric displays.

### SUMMARY OF THE INVENTION

An embodiment of the invention may therefore comprise a method for selecting items from a list, the method comprising displaying a plurality of items from at least one list in a rotational listing and displaying a trove associated with the rotational listing, wherein the rotational listing is rotatable and enabled to display a pre-determined number of items from the list, and the trove is enabled to hold any items from the list which are not displayed on the rotational listing.

An embodiment of the invention may further comprise a graphical user interface, the graphical user interface being enabled to display in a plurality of locations in the graphical user interface a plurality of list items, the locations forming a first rotational listing, display a trove associated with the first rotational listing, wherein the first rotational listing is rotatable and enabled to display a pre-determined number of items from the list, and the trove is enabled to hold any items from the list which are not displayed on the first rotational listing.

An embodiment of the invention may further comprise a method of selecting items from at least one list, the method comprising displaying at least one plurality of items from at least one list in a 3D rotational listing, and displaying at least one trove associated with at least one plurality of items, wherein the 3D rotational listing is rotatable and enabled to display a predetermined number of items from the at least one list, and the at least one trove is enabled to hold any items from the at least one list which are not displayed on the 3D rotational listing.

### BRIEF DESCRIPTION OF THE DRAWINGS

FIG. 1 shows a dial based user interface with multiple click (request) points and drag and drop support in 2D.

FIG. 2 shows a dial based user interface with multiple click (request) points and drag and drop support in 3D.

FIG. 3 shows a dial based user interface with multiple click (request) drop support in 2D.

FIG. 4 shows a dial based user interface with multiple click (request) drag support in 2D.

FIG. 5 shows touch being used to determine the speed of rotation of a dial.

FIG. 6 shows a double touch being used to determine the speed of rotation of a dial.

FIG. 7A shows a rotational based user interface with multiple click (request) points and drag and drop support in 3D.

FIG. 7B shows a rotational based user interface with multiple click (request) points and drag and drop support in 3D.

FIG. 7C shows a rotational based user interface with multiple click (request) points and drag and drop support in 3D.

FIG. 8A shows a rotational list with a number of items in the trove.

FIG. 8B shows a rotational list with a number of items in the trove.

FIG. 8C shows a rotational list with a number of items in the trove.

FIG. 9A shows a rotational list with a number of items in a trove.

FIG. 9B shows a rotational list with a number of items in a trove.

FIG. 9C shows a rotational list with a number of items in a trove.

FIG. 9D shows a rotational list with a number of items in a trove.

FIG. 10A shows multiple troves and multiple lists in a rotational list.

FIG. 10B shows multiple troves and multiple lists in a rotational list.

FIG. 10C shows multiple troves and multiple lists in a rotational list.

FIG. 10D shows multiple troves and multiple lists in a rotational list.

### DETAILED DESCRIPTION OF THE EMBODIMENTS

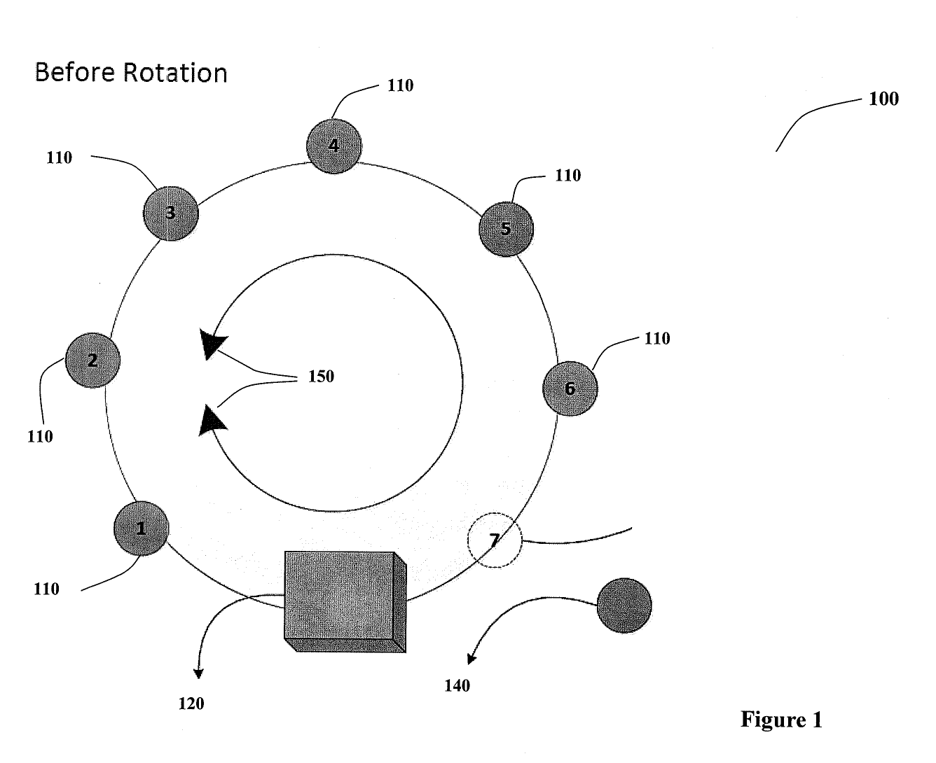

FIG. 1 shows a dial based user interface, before rotation, with multiple click (request) points and drag and drop support in 2D. The rotary dial 100 comprises a number of items 110. It is understood that the items 110 may be comprised of text, images, icons, links or other representations. Further it is understood that the items 110 may be uniform in their display or may be comprised of a mixture of text, images, icons, links or other representations. For instance, a first item 110, e.g. item 1, may be an icon, a second item 110, e.g. item 2, may be text and a third item 110, e.g. item 3, may be a link. However, all of the items 110 may be icons. A user may determine whether to uniformly display items 110 in the dial 100 or to display each item 110 in a different fashion. The manner in which items 110 are displayed may also be automated or predetermined. Particular types of items 110 may be automatically shown in a particular format based on the type of the item. For instance, a workflow item may be shown in text whereas a calendar item may be show as an icon.

The rotary dial may also comprise a trove 120. The trove 120 provides a location in the rotary dial where items 110 are contain when passing to or from the rotational portion of the dial. As shown in FIG. 1, there are seven (7) items 110 in the rotational dial. It is understood that there may be more or fewer items 110 shown in the rotary dial 100 outside of the trove 120. More or fewer items 110 may be shown in the dial 100 by changing the size of each item 110. The altered size may be of the text, image or icon or whatever form the item 110 takes in the particular dial. The spacing on the dial between each item 110 may also be affected to allow more or fewer items 110 in the dial 100. A user may set a maximum or minimum spacing to allow the dial items 100 to be set from each other. Further, the dial 100 may automatically show more or fewer items depending on the total number of items 110 in the list. For instance, the dial 100 may automatically display a single item 110 from the trove 120 when there is only one item in the trove 120. This may eliminate the need for the user to scroll items 110 in and out of the trove 120 when limited items 110 are present.

Items 110 may be dragged and dropped in a user interface supporting a rotational list 100. An item dragged to the rotational list 100 may be presented in the list according to a determined sorting order. This sorting order may be based on any number of factors such as priority, sequence of being applied to the list, or other sorting factor determined by a user or an application manager. It is understood that any imaginable sorting definition can be applied to the list. Further, multiple items 110 may be dragged or dropped to the list at one time. The list 100 will automatically arranged the multiple items 110 using a current configuration of the list 100. It is understood, that as an individual item, or multiple items, are dragged out of the list, the rotational list 100 will automatically replace the dragged items with items from the trove 120, to the extent that the trove has enough items to replace the dragged items.

FIG. 1 shows an item 130 being dragged from the list 100. This item 130, as discussed above, will be replaced with an item from the trove 120 by a current, or pre-defined, sorting algorithm. Also shown in FIG. 1 is an item 140 being dropped in the list 100. The dropped item 140 may be dropped anywhere in the rotational list 100. It is not required that the dropped item 140 be dropped in a sorted location in the list 100. The dropped item 140 is allocated to an appropriate position in the list 100 according to a current, or pre-defined, sorting algorithm. The appropriate position in the list 100 may be in the rotational dial 100 or in the trove 120.

Also shown in the dial 100 of FIG. 1 is a rotation indicator 150. The dial 100 may be rotated clockwise as well as counter clockwise. It is understood that the rotation indicator 150 may not be visible or functional on a dial 100 and is shown to illustrate the possible directions of rotation of the dial 100.

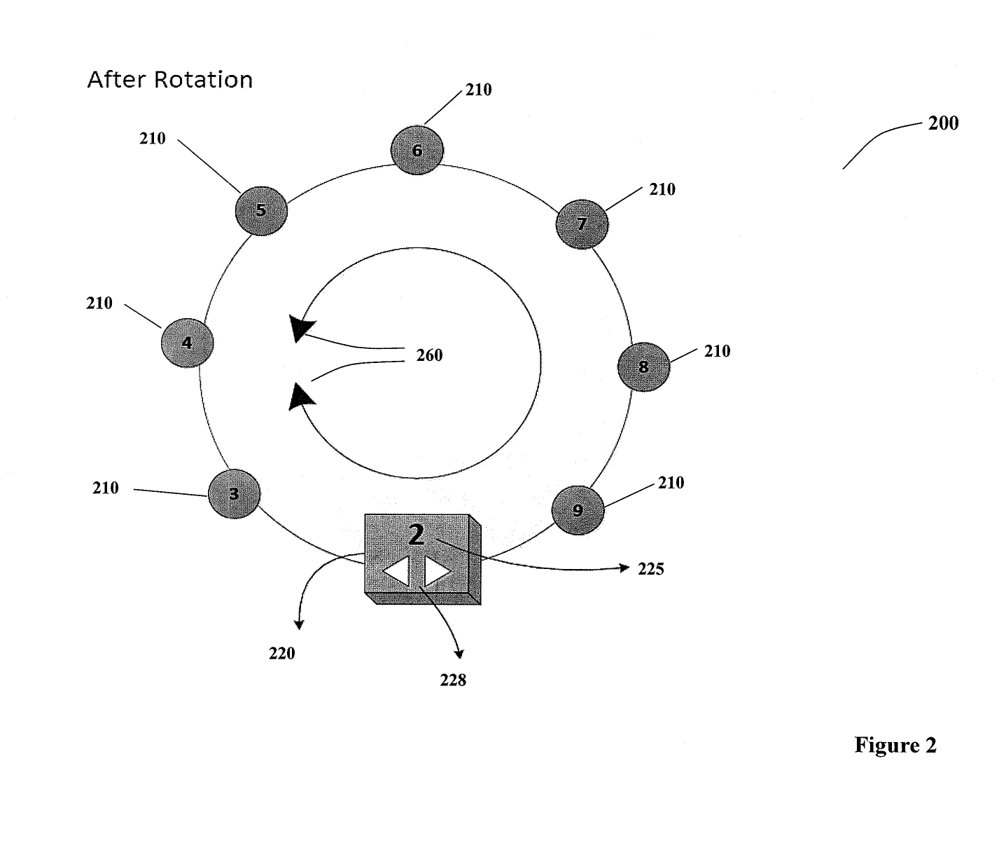

FIG. 2 shows a dial based user interface, after rotation, with multiple click (request) points and drag and drop support in 2D. The dial 100 comprises a plurality of items 210 shown on the dial and a trove 220. After items have dragged or dropped to the dial 100 as discussed in regard to FIG. 1, all items 210 in the list 100 will either show along the rotational dial or will be in the trove 220. The trove 220 may have an indicator 225 which will show the number of items which are currently in the trove 220. Here, there are 2 items in the trove 220 as shown by the indicator 225. As further items are dropped to or dragged from the dial 200, the number shown in the indicator 225 will be updated dynamically. Accordingly, if an additional item is dropped to the dial, that item may either show on the dial, thus pushing an existing shown item to the trove 220, or it may be placed in the trove 220. Either way, an additional item will be present in the trove 220 and the trove will automatically and dynamically update to show that there 3 items in the trove 220, as would be displayed by the indicator 225.

The trove 220 may also comprise direction arrows 228. The direction arrows 228 may be used to manipulate the items 210 shown on the dial 200. The arrows 228 may be used to perform the manipulation with a mouse pointer or using a 1-finger touching action in a touch based interface. For instance, a single mouse click or finger touch on the left arrow 228 may cause the dial to rotate items 210 one position to the left. In such a situation, an item may be moved from the trove 220 to the 3 item 210 location and the 9 item 210 may be moved into the trove. It is understood that different dynamics can apply to the direction arrows 228. For instance, a double mouse click or finger touch on one arrow may cause the dial 200 to slowly rotate in a particular direction corresponding to the arrow clicked or touched. Also, a continuous right mouse click (for example) or continuous finger touch on one arrow may cause the dial 200 to slowly rotate in a particular direction corresponding to the arrow clicked or touched. The speed of the rotation may be pre-defined and may be alterable by a user. Once a rotation of the dial 200 has been initiated, by whatever action is made to so manipulate the dial 200, the rotation may be ceased by a secondary action of the user. For instance, a single mouse click or finger touch on either one of the arrows 228, or anywhere on the dial 200. It is understood that the discussed methods of causing rotation in the dial 200 are for illustration purposes.

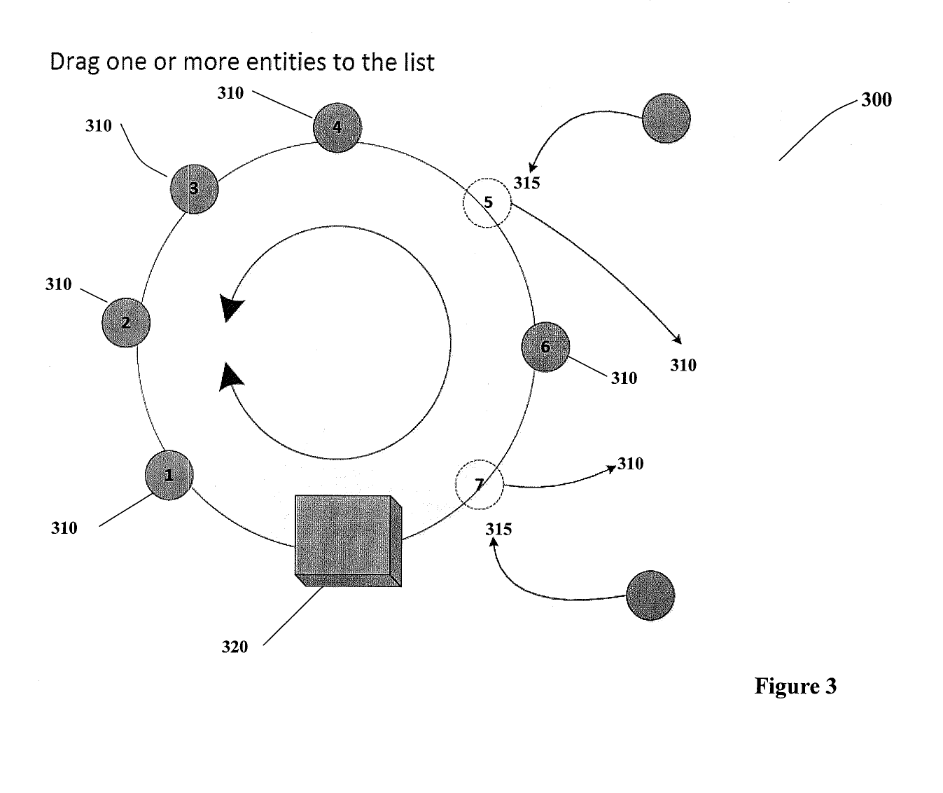

FIG. 3 shows a dial based user interface with multiple click (request) drop support in 2D. The dial 300 comprises a plurality of items 310 and a trove 320. As discussed above, either single items 310 or multiple items can be dropped on the dial 300 at a particular time. A mouse click drop may be utilized to drop multiple drop items 315 to the dial 300. A double, or triple for example, finger touch may be utilized to drop multiple items 315 on the dial 300. Any available means of user interface may be used to group the items 315. A current, or pre-defined sorting algorithm may place the drop items 315 in a sorted fashion as discussed above. The drop items may display on the dial 300 or may be placed in the trove 320 according to the appropriate sorting algorithm.

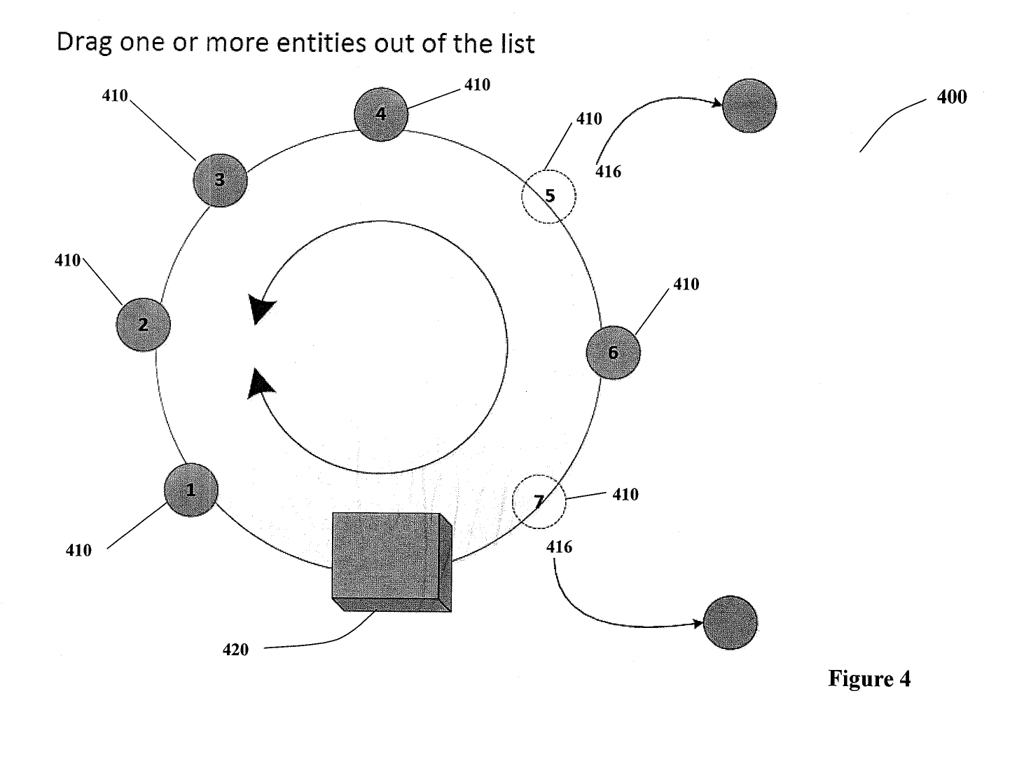

FIG. 4 shows a dial based user interface with multiple click (request) drag support in 2D. The dial 400 comprises a plurality of items 410 and a trove 420. As discussed above, either single items 410 or multiple items can be dragged from the dial 400 at a particular time. A mouse click drag may be utilized to drag multiple items 416 from the dial 400. A double, or triple for example, finger touch may be utilized to drag multiple items 416 from the dial 400. Any available means of user interface may be used to group the items 416. A current, or pre-defined sorting algorithm may place the dragged items 416 in an appropriate place. An action can be defined by a user, or be pre-defined, for what needs to occur for the entities being dragged out of the dial 400. For instance, the dragged items 416 may be placed in a trash bin icon. A curren, or pre-defined sorting algorithm may replace the dragged items 416 with items from the trove 420 as appropriate.

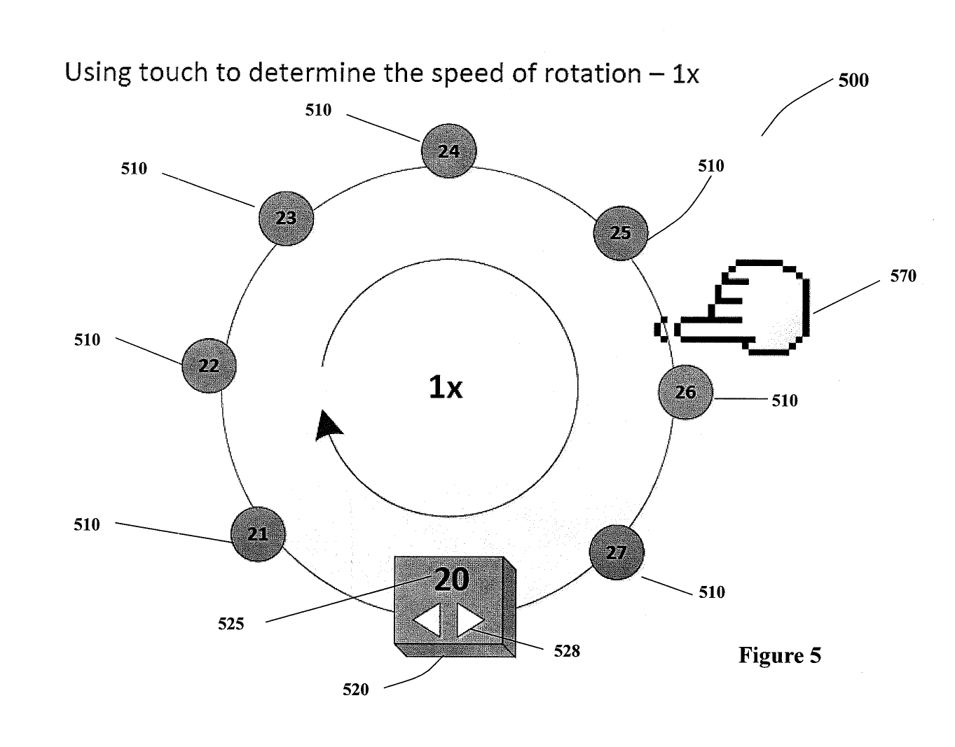

FIG. 5 shows touch being used to determine the speed of rotation of a dial. A dial 500 comprises a plurality of items 510 and a trove 520. The trove 520 may comprise direction arrows 528 and a number indicator 525. As noted previously, the dial 500 rotation may be manipulated using the direction arrows 528 (see discussion regarding FIG. 2). The dial 500 rotation may also be manipulated using the dial 500 itself. A single finger touch 570 may cause the dial 500 to rotate in the direction of the finger touch. The dial 500 may rotate at a pre-defined speed with the finger touch remaining in a single location. The dial 500 rotation speed may be changed by moving the finger touch 570 along the dial 500 circumference. For instance, the finger touch in FIG. 5 shows the touch between the items 510 25 and 26. The finger touch 570 may be moved toward the 25 (top of the circumference of the dial 500) to cause a degree of faster rotation. Likewise, the finger touch 570 may be moved in the direction of the item 26 (toward the bottom of the dial 500 or the trove 520) to cause a degree of slower rotation. In this manner, the rotation of the dial can be controlled by a user as the spinning dial 500 gets closer to displaying an item 510 of interest to the user. In FIG. 5, the trove 520 shows that there are 20 items not currently shown along the circumference of the dial. The dial rotation speed can be manipulated as disclosed to more quickly arrive at a desired item 510. It becomes evident that rotation speed manipulation may be particularly helpful for a trove that contained a substantial number of items. Further, a dial 500 rotation speed may be slowed to allow a user to identify the items 510 as they come out of the trove 520. The dial 500 rotation may require that a finger touch 570 be maintained during the rotation. When the finger touch 570 is removed, the rotation may cease. Also, a single finger touch 570 may initiate the rotation with the speed of the rotation being subject to the location of the finger touch 570. A single touch and removal may also only be able to cause a single speed rotation of the dial 570. While FIG. 5 shows a single touch 570 on the right side of the dial 500 to cause a rotation in a particular direction, it is understood that a single touch in the manner described may be applied to the left side of the dial 500 to cause rotation in the opposite direction.

Although FIG. 5 shows a touch manipulation with a touch sensitive user interface, it is understood that a mouse click may also be used to manipulate the rotation of the dial 500. For instance, a mouse click at the location of the finger touch 570 may cause rotation at a particular speed. A held mouse click may cause rotation until the mouse click is released. Hovering a cursor over a location of the dial 500 may cause rotation of the dial 500. The right and left mouse buttons may be used to manipulate the rotation of the dial 500 in different manners. For instance, a right mouse click may cause a first rotation speed and a left mouse click may cause a second rotation speed.

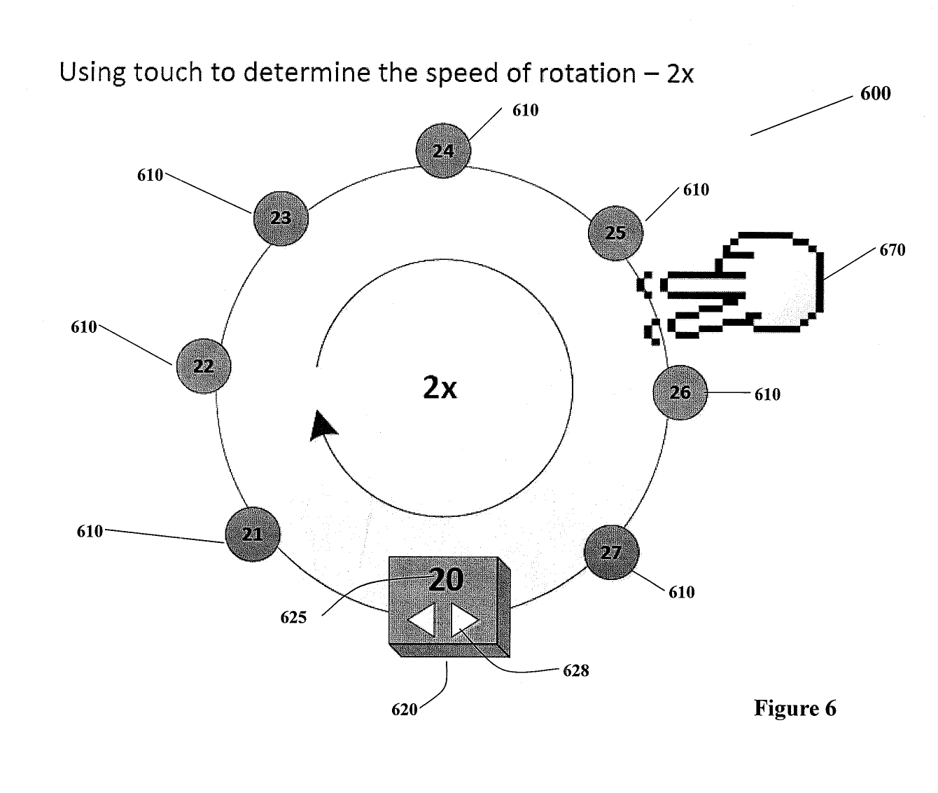

FIG. 6 shows a double touch being used to determine the speed of rotation of a dial. A dial 600 comprises a plurality of items 610 and a trove 620. The trove 620 may comprise direction arrows 628 and a number indicator 625. As noted previously, the dial 600 rotation may be manipulated using the direction arrows 628 (see discussion regarding FIG. 2) or with a single touch (see discussion regarding FIG. 5). The dial 500 rotation may also be manipulated using a double finger touch 670 of the dial 600. This may be used in combination with the single finger touch 570 described in regard to FIG. 5. A single finger touch 570 may cause the dial to rotate at a particular speed. A double finger touch 670 may cause the dial to rotate at a second particular speed, e.g. twice the speed of a single finger touch 570. This may eliminate the need for moving a single finger touch 570 to manipulate the rotation speed of the dial 500. However, a single finger touch 570 and a double finger touch 670 may be used in combination with the methods described in conjunction with FIG. 5. For instance, a double finger touch 670 may cause rotation of the dial until the double finger touch 670 is removed. A double finger touch 670 may also cause rotation after removal. The rotation may be ceased by touching the dial again with a single or double finger touch. For a trove 620 that contains numerous un-displayed items, dial 600 rotation speed manipulation may be helpful to move the list to a desired location. While FIG. 6 shows a double touch 670 on the right side of the dial 600 to cause a rotation in a particular direction, it is understood that a double touch in the manner described may be applied to the left side of the dial 600 to cause rotation in the opposite direction.

Although FIG. 6 shows a touch manipulation with a touch sensitive user interface, it is understood that a mouse click may be used to manipulate the rotation of the dial 600. For instance, a double mouse click at the location of the finger touch 670 may cause rotation at a particular speed. A third mouse click, or other method, may be used to cause the dial 600 to cease rotating.

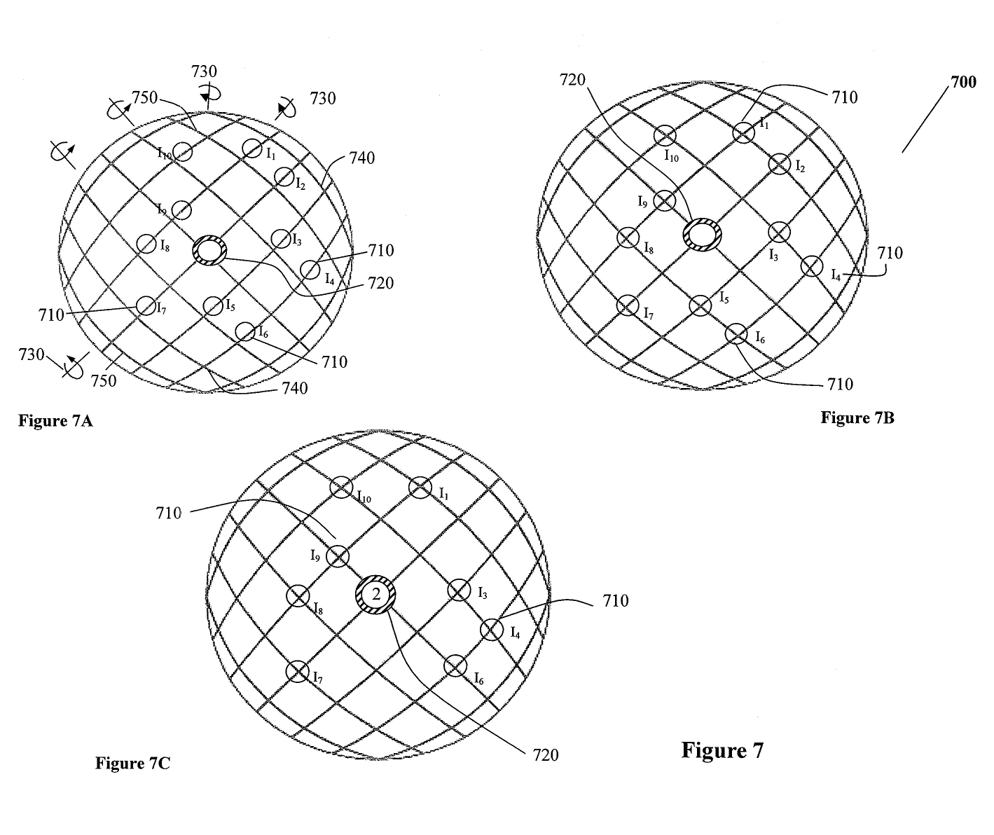

FIG. 7A-C show a rotational based user interface with multiple click (request) points and drag and drop support in 3D. The rotational list 700 comprises a plurality of items 710 and a trove 720. The rotational list 700 is a 3D representation of a list similar to those depicted as examples in FIGS. 1-6. It is understood that those depicted in FIGS. 1-6 are 2D examples. The rotational list 700 may be rotated on all possible planes 730. The rotational list 700 is shown in FIG. 7A with latitude and longitude type intersections 740. The rotational list 700 may have the items 710 spaced throughout the sphere at the intersections 740. The rotational list 700 may have the items 710 spaced throughout the sphere in between the intersections 740—in the spaces. For the ease of discussion, it will be assumed that the items 710 are displayed at the intersections as shown in FIG. 1 for the remainder of this description. Each intersection 740 may display one item 710. The number of lines 750 can be increased or decreased to provide increased or decreased intersections 740. As the rotational list 700 is rotated, the items will rotate likewise with the intersections 740. The intersection lines 750 may or may not be visibly displayed. A trove 720 is displayed in the center of the rotational list 700. The trove 720 may be state, i.e. non-moveable.

In FIG. 7A-C, the rotational list 700 is displayed as a sphere. It is understood that the list may displayed as any 3D object. The items 710 may be dropped in the trove 720 in a similar manner to items discussed in regard to FIGS. 1-6. This is shown in FIG. 7B. Single items 710 may be dropped in the trove 720 and multiple items 710 may be dropped in the trove 720. A touch sensitive GUI may be utilized to display the rotational list 700. A GUI responsive to mouse clicks may be used to display the rotational list 700.

The rotational list 700 in FIG. 7B shows items 710 being dropped in the trove 720. Items 710 may be dropped on the rotational list 700 and a sorting algorithm may determine which items to display and which items to push to the trove 720.

FIG. 7C shows the rotational list 700 subsequent to the items dropped into the trove 720 depicted in FIG. 7B. The trove 720 may show the number of items currently in the trove 720.

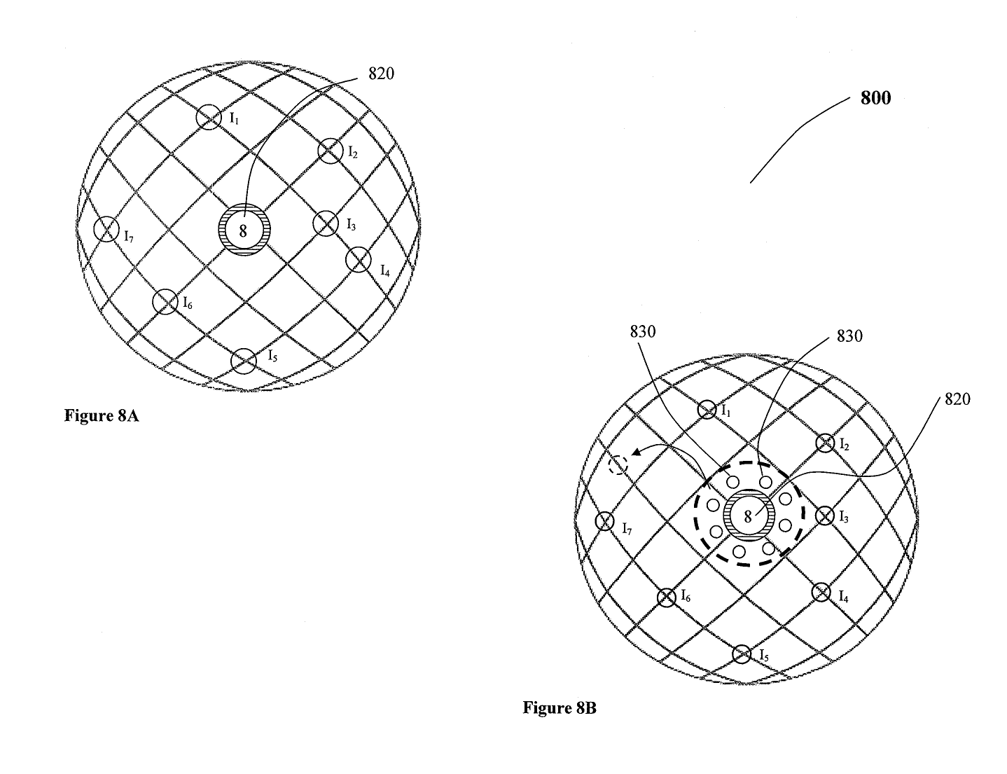

FIG. 8A-B show a rotational list with a number of items in the trove. As shown, the trove 820 of the rotational list 800 indicates that there are 8 items in the trove 820. A finger touch may be used, with a single tap of the trove 820 for example, to open the trove 820. The trove items 830 may be displayed after such a tap as orbiting the trove 820. This may be used to provide a user an opportunity to view items in the trove 820 without rotating items 810 in and out of the trove 820. In an embodiment of the invention, a finger touch tap may also be used to expand the trove 820 in a manner where it sits on top of the rotational list 800 in a transparent or translucent manner. The trove 820 may still be orbited by the trove items 830 with the expanded, enlarged, view providing easier viewing to a user.

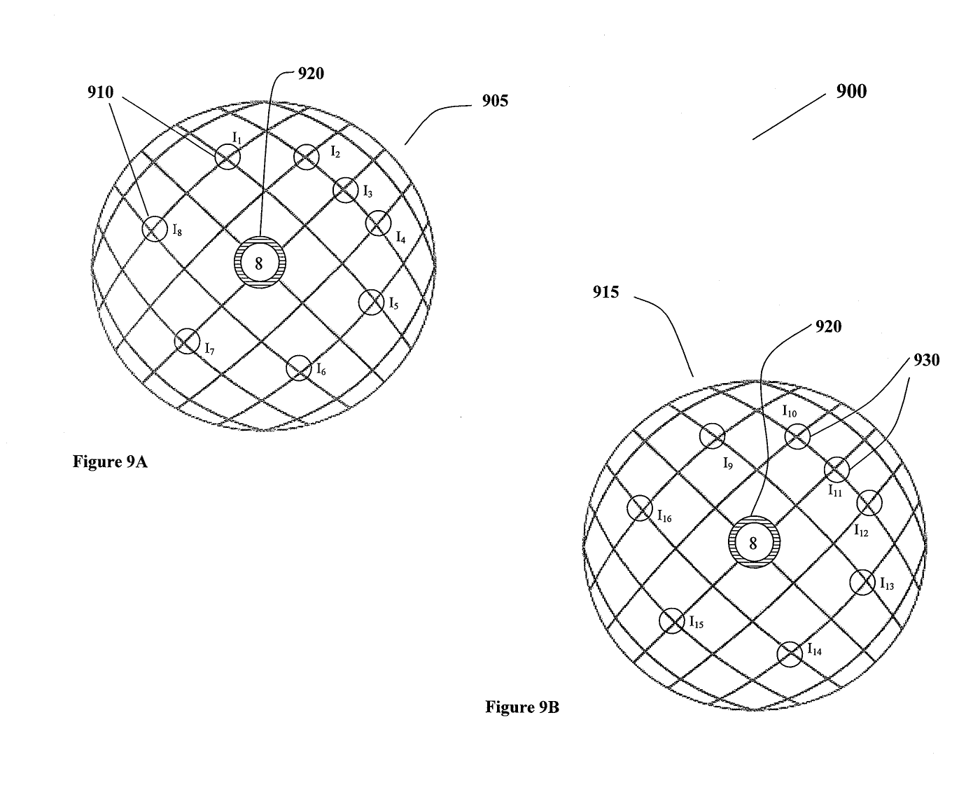

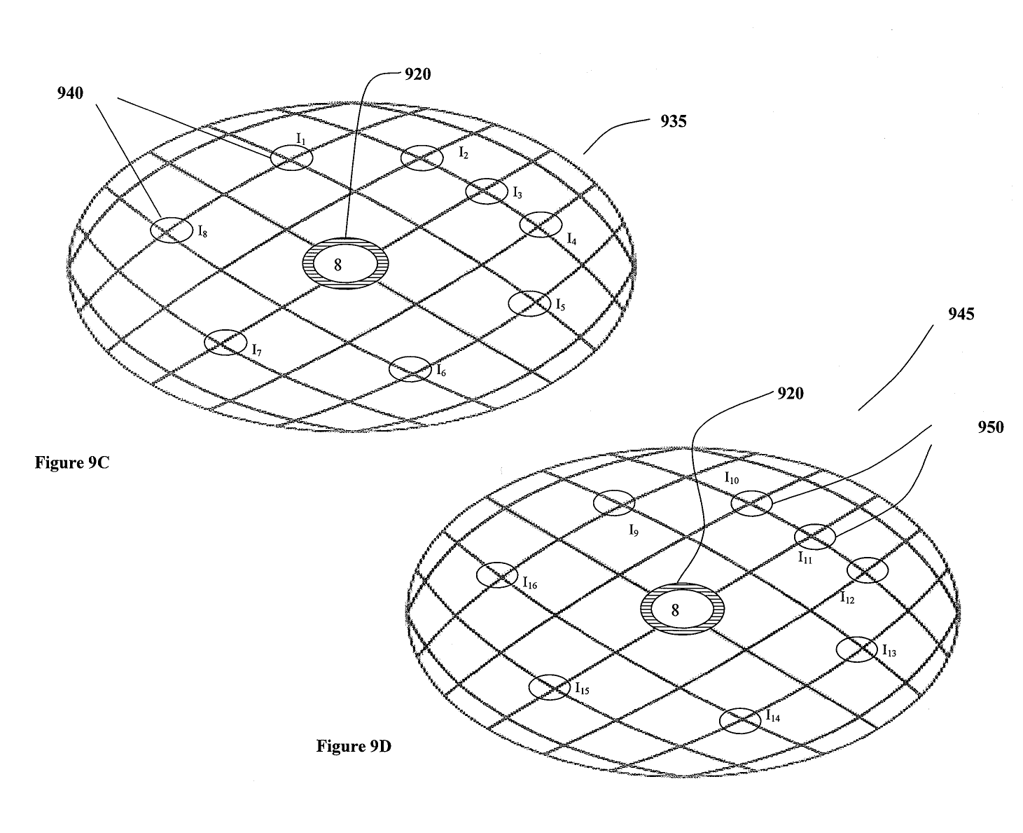

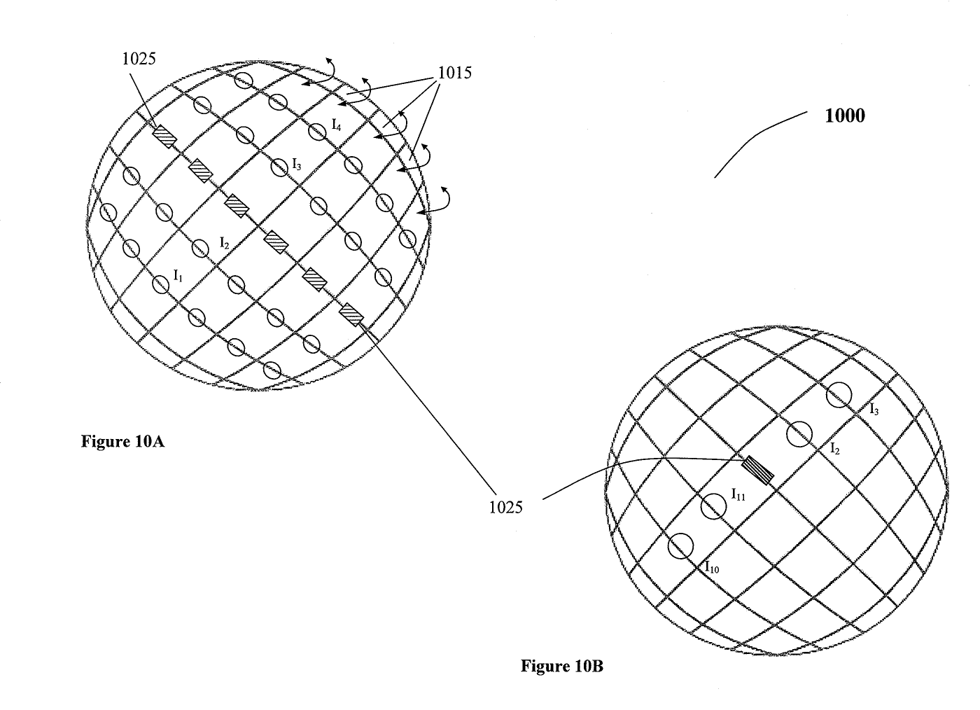

FIG. 9A-D show a rotational list (in 3D) with a number of items in a trove. As shown, the trove 920 of the rotational list 900 indicates that there are 8 items in the trove 920. The trove 920 may be opened by a double tap for a touch sensitive interface or with a double mouse click. The double tap may swap the trove items 930 with the items 910 outside of the trove 920. A second double click would return the display to its previous status. The rotational list 900 may be rotated is the described manner. It is understood that there may be more items in the trove 920 than the rotational list 900 is able to display. In such a situation, a double click will display those items in the trove 920 according to a current, or pre-determined, sorting algorithm, such as priority or frequency for example. It is understood that a double mouse click may display trove 920 items in a similar manner.

As shown in FIGS. 9, FIG. 9A and FIG. 9B show representations of spherical rotational lists. The lists 905, 915 are spheres wherein the outermost portions of the list are substantially equidistant from the center of the sphere. As the case may be, and as shown in FIGS. 9A-B, the trove 920 resides at the center of the lists 905, 915. FIGS. 9C and 9D show representations of non-spherical rotational lists 935, 945. The lists 935, 945 are elliptical wherein the outermost portions of the list are at differing distances from the center of the center. It is understood that the dimensions of the elliptical rotational lists 935, 945 may vary depending on the desires of a user or an administrator. The dimensions, such as the semi-major axis and the semi-minor axis, may be customized and may be dynamic according to a user's input.

The varying shapes shown in FIGS. 9A-B and contrasted with FIGS. 9C-D are here shown for purposes of examples. It is understood that the shape of a rotational list may be any shape that is rotatable. For example, a rotational list may be cubical, or rectangular or conical, in order to present a flatter face to a use and thereby present any shown icons on the front face in equal size. Moreover, it is understood that the directions of rotation may be restricted to particular axis. For example, in a cubical list, the directions of rotation may be limited to up and down, and left and right, to coincide with the x and y axis. A function controlling the directions of rotation may be selectable by a user. The user may opt to limit the rotation or the user may opt to not limit rotation to allow rotation free of any axis limitations.

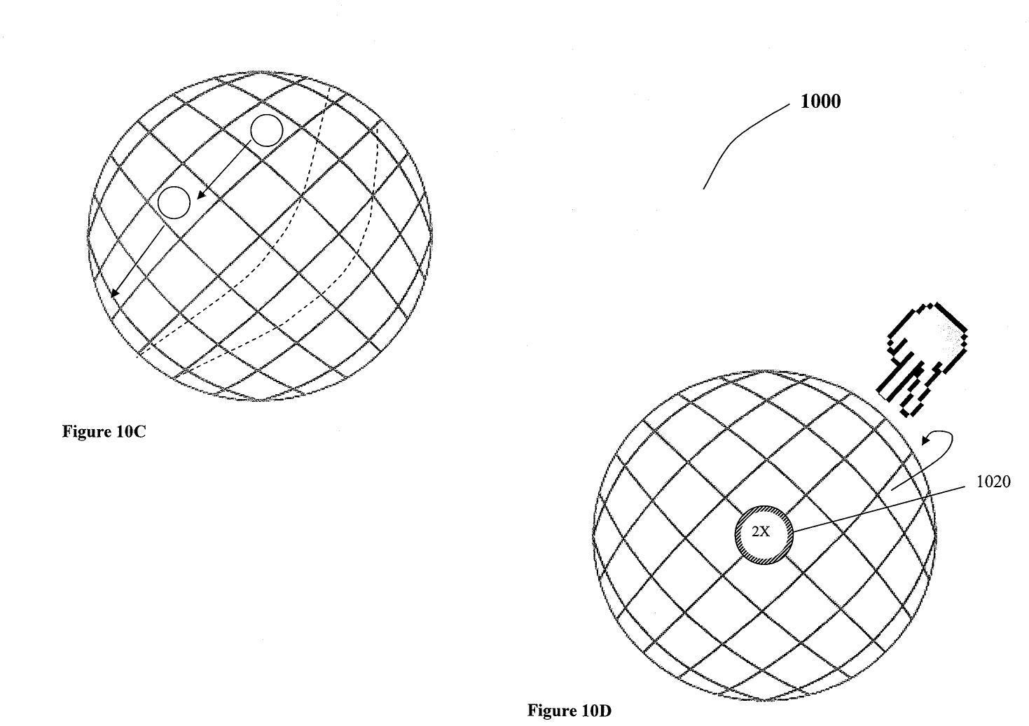

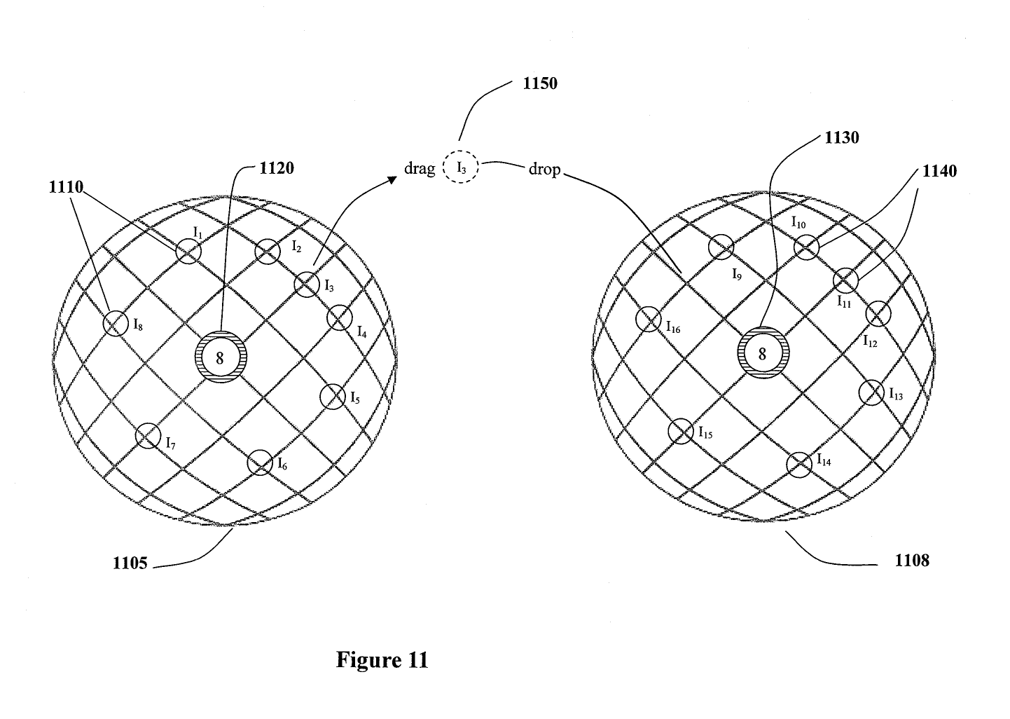

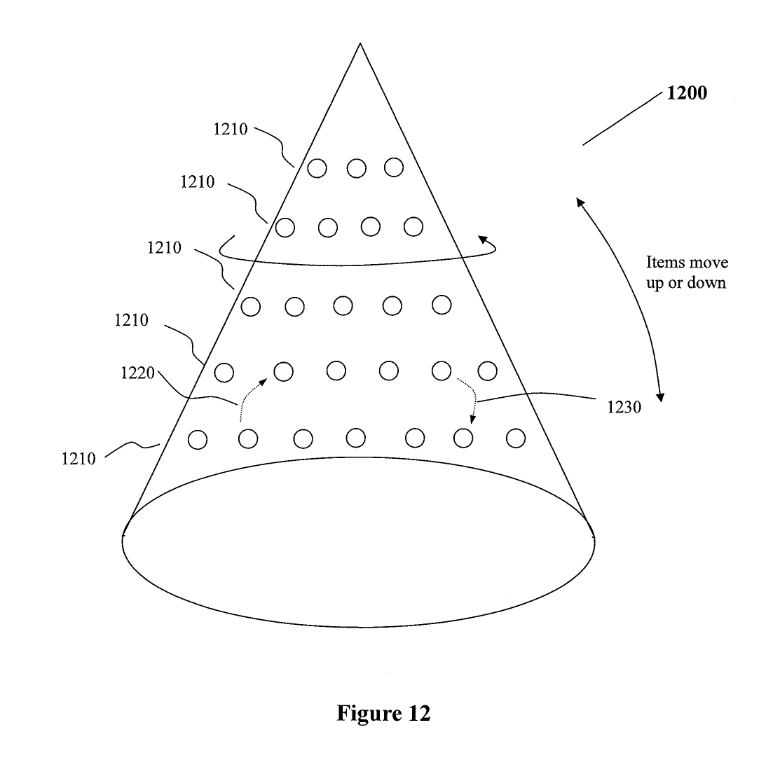

FIG. 10A-D show multiple troves and multiple lists in a rotational list. The rotational list 1000 may comprise multiple troves 1025 and multiple lists 1015. Each list 1015 may be individually manipulated with a finger touch or a mouse click. Further, each individual list may be manipulated with associated list items going into and coming out of the associated trove 1025 in a manner similar to the rotational lists described in FIGS. 1-6. Each trove 1025 may be utilized for particular tasks or purposes as desired by a user. A particular trove 1025 may be selected for display similar to that depicted in FIGS. 7-9. For instance, a double finger tap, for example, may be used to select one trove 1025 and associated list from FIG. 10A to be displayed. Any manner of selection may be used to return the rotational list 1000 to the multiple trove and multiple list view.

A finger fling movement, as opposed to a finger tap may he used to rotate the entire rotational list 1000 in 3D. Speed and direction of the rotation may be controlled by the direction and speed of the finger fling as shown in FIG. 10C. As shown in FIG. 9D, the speed and direction of rotation in a plane may be based on the placement of fingers relative to the list 1000. The speed of the rotation may be based on the number of fingers utilized by a user.

FIG. 11 shows two lists simultaneously for a drag/drop operation. A first rotational list 1105 and a second rotational list 1108 are show with trove 1120 and trove 1130, respectively. The first list 1105 has a number of items 1110 displayed. The second list 1108 has a number of items 1140 displayed. An item from one list, for instance the first list 1105, may be dragged from its position and dropped in another list, for instance the second list 1108. The drag and drop operation may be performed with a single finger continuous movement action from the first list 1105 to the second list 1108. The drag and drop operation may also be performed with multiple single finger continuous movements. For example, FIG. 11 shows a holding location 1150 where an item from one list may be dropped. As such, one or more items from the first list 1105 may be dragged and dropped in the holding location 1150 and one or more items from the second list 1108 may be dragged and dropped in the holding location 1150. A third list, not shown, may be swapped for one of the existing lists 1105, 1108. The items from the holding location 1150 may be dragged and dropped from the holding location 1150 to the third list. In this manner, items from different lists may be consolidated or switched between lists.

FIG. 12 shows a conical 3D shaped rotatable user interface. A conical 3D user interface 1200 may be used to provide prioritization to lists 1210. Lists 1210 with higher priority may be pushed upward toward the narrower, or upper, portion of the cone interface 1200. Priority of the items in the lists may be determined by the frequency of use by a user. An item from a list 1210 may move up 1220 to a higher priority list 1210 and may replace an item in that list which is similarly moved down 1230 to a lower priority list. A user may also be enabled to determine priority by manually moving an item from one list to another, higher or lower, list. The radius of the list 1200 may be inversely proportional to the importance, or frequency, of a list item, as determined either automatically or manually.

It is understood that prioritization of items in the lists 1210 may be determined by any number of factors. Multiple factors may be used to determine priority. In the above discussion, frequency was utilized in a descriptive manner and is not intended to limit the disclosure to frequency. Further, a user may be enabled to identify one or more factors that determine, or influence, importance. These may include, but are not limited to, topic, timing, frequency, interest, or other factors.

While not shown in FIG. 12, it is understood that a trove may be utilized to store excess or overflow items from each list 1210. A trove may be assigned to each list 1210 and may reside anywhere within the cone, or outside the cone, such as immediately to the right of a corresponding list 1210.

The drag operation, either to the holding location 1150 or from a first list 1105 to a second list 1108, may either be cut and paste operations or may be copy and paste operations. Which type of operation may be selectable by a user from a menu, not shown. Also, upon dragging and dropping from one location to another, either a holding location 1150 or another list, the user may be queried regarding which type of operation is desired.

It is understood, in regard to the drag and drop operations discussed with regard to FIG. 11, that different shaped lists may be used. An item from a spherical, or circular, list may be dragged and dropped to a cubical, or square, list.

Massively multiplayer online role-playing games (MMORPG) generally utilize a plurality of lists which a player can access to play the game. For instance, in war type/civilization type games, a player may desire to choose from one of attack, defense, resources, buildings or farm items. It is understood that rotational lists may be utilized in such MMORPG games. Also, it is understood that a MMORPG player may be enabled to create custom lists by dragging and dropping items from other standard lists in a MMORPG game.

Throughout the disclosure, specific finger touch and mouse click actions are used to provide examples of actions which may be used to manipulate the lists, troves and items. It is understood that these are merely examples of possible actions, such as a mouse double click, that may be used by a user. The described elements may be manipulated in any manner to obtain the desired results. For instance, a mouse double click may be replaced with a right, or left click. A drag and drop may be replace with a right or left click, or a double click. A single finger tap may be replaced with with a prolonged touch prompting a user to choose an action from a menu.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for selecting items from a list, said method comprising:
displaying a plurality of items from at least one list in a rotational listing; and
displaying a trove associated with said rotational listing;
wherein said rotational listing is rotatable and enabled to display a pre-determined number of items from said list, and said trove is enabled to hold any items from said list which are not displayed on said rotational listing.

2. The method of claim 1, wherein said rotational listing is rotatable in both a clockwise and a counter-clockwise direction.

3. The method of claim 1, further comprising rotating said rotational list.

4. The method of claim 3, wherein during said process of rotating said rotational list at least one item from said list is placed in said trove and at least one item from said list emerges from said trove to be displayed on said rotational list.

5. The method of claim 4, wherein said rotational list is rotatable in at least two speeds.

6. The method of claim 1, wherein said rotational list is rotatable in at least two speeds and predefined user interface manipulation controls which of said at least two speeds to rotate said rotational list.

7. The method of claim 1, further comprising:
rotating said rotational list, wherein during said process of rotating said rotational list at least one item from said list is placed in said trove and at least one item from said list emerges from said trove to be displayed on said rotational list; and
dropping at least one item from outside said rotational list onto said rotational listing wherein said circular listing is sorted in a pre-determined manner to assign the dropped item to the appropriate position in said rotational listing.

8. The method of claim 7, wherein said process of dropping at least one item from outside comprises dropping at least two items from outside simultaneously

9. The method of claim 1, further comprising:
rotating said rotational list, wherein during said process of rotating said rotational listing at least one item from said list is placed in said trove and at least one item from said list emerges from said trove to be displayed on said rotational list; and
dragging at least one item from said rotational listing wherein said rotational listing is sorted in a pre-determined manner to assign items from the trove to replace said at least one dragged items.

10. The method of claim 9, wherein said process of dragging at least one item from said rotational listing comprises dragging at least two items from said rotational listing simultaneously.

11. The method of claim 7, further comprising defining an action for handling items dragged from said rotational listing.

12. The method of claim 1, further comprising:
rotating said rotational list, wherein during said process of rotating said rotational list at least one item from said list is placed in said trove and at least one item from said list emerges from said trove to be displayed on said rotational list;

13. A graphical user interface, said graphical user interface being enabled to:
display in a plurality of locations in said graphical user interface a plurality of list items, said locations forming a first rotational listing;
display a trove associated with said first rotational listing
wherein said first rotational listing is rotatable and enabled to display a pre-determined number of items from said list, and said trove is enabled to hold any items from said list which are not displayed on said first rotational listing.

14. The graphical user interface of claim 13, wherein said first rotational listing is rotatable in both a clockwise and a counter-clockwise direction.

15. The graphical user interface of claim 13, wherein the trove is further enabled to absorb at least one item and to yield at least one item upon rotation of said first rotational listing.

16. The graphical user interface of claim 13, wherein said first rotational listing is rotatable in at least two speeds.

17. The graphical user interface of claim 13, wherein said first rotational listing is rotatable in at least two speeds and predefined user interface manipulation controls which of said at least two speeds is operable.

18. The graphical user interface of claim 13, wherein said graphical user interface is further enabled to accept at least one item dropped from outside the first rotational listing and wherein said first rotational listing is sorted in a pre-determined manner to assign the dropped item to the appropriate position in said first rotational listing.

19. The graphical user interface of claim 18, wherein said at least one item comprises at least two items dropped from outside simultaneously.

20. The graphical user interface of claim 13, wherein said graphical user interface is further enabled to have at least one item dragged out of the first rotational listing and wherein said first rotational listing is sorted in a pre-determined manner after items are dragged from the first rotational listing.

21. The graphical user interface of claim 13, wherein said graphical user interface is further enabled to have at least one item dragged out of the first rotational listing and dropped into a second rotational listing.

22. The graphical user interface of claim 13, wherein said graphical user interface is further enabled to have at least one item dragged out of the first rotational listing and dropped into a holding area.

23. The graphical user interface of claim 22, wherein said graphical user interface is further enabled to have the at least one item dragged out of the first rotational listing and dropped into a holding area, and dragged from said holding area and dropped into a second rotational listing.

24. A method of selecting items from at least one list, said method comprising:
displaying at least one plurality of items from at least one list in a 3D rotational listing; and
displaying at least one trove associated with at least one plurality of items;
wherein said 3D rotational listing is rotatable and enabled to display a predetermined number of items from said at least one list, and said at least one trove is enabled to hold any items from said at least one list which are not displayed on said 3D rotational listing.

25. The method of claim 24, wherein each of said at least one trove is associated with one of said at least one plurality of items.

26. The method of claim 25, wherein each of said plurality of items is enabled to be rotated individually along an axis of said 3D rotational listing.

27. The method of claim 25, wherein said 3D rotational listing is rotatable in all planes.

28. The method of claim 27, wherein said 3D rotational list is rotatable in at least two speeds.

29. The method of claim 24, wherein said 3D rotational listing is enabled to accept at least one item dropped from outside said 3D rotational listing and wherein said 3D rotational listing is sorted in a pre-determined manner to assign the dropped at least one item to an appropriate position in said 3D rotational listing.

30. The method of claim 24, wherein said 3D rotational listing is enabled to accept a plurality of items dropped from outside said 3D rotational listing and wherein said spherical listing is sorted in a pre-determined manner to assign the dropped plurality of items to an appropriate position in said 3D rotational listing.

31. The method of claim 24, wherein said 3D rotational listing is enabled to have at least one item dragged from said 3D rotational listing and wherein said 3D rotational listing is sorted in a pre-determined manner to assign items from the at least one trove to replace said at least one dragged item.

32. The method of claim 24, wherein said 3D rotational listing is enabled to have a plurality of items dragged from said 3D rotational listing and wherein said 3D rotational listing is sorted in a pre-determined manner to assign items from said at least one trove to replace said plurality of dragged items.
